(19) United States
(12) Patent Application Publication
(10) Pub. No.: US 2012/0076107 A1
(43) Pub. Date: Mar. 29, 2012

(54) AUTONOMOUS SCANNING AND HANDOVER

(76) Inventors: Shlomo Avital, Nataf (IL); Ofer Markovits, Haifa (IL); Miri Ratner, Ramat-Gan (IL)

(21) Appl. No.: 12/888,573

(22) Filed: Sep. 23, 2010

(51) Int. Cl. H04W 36/00

(52) U.S. Cl. 370/331

(57) ABSTRACT

In some embodiments a network adapter comprises a first network access technology and a second network access technology and a controller comprising logic to locate an available network which utilizes the first network access technology and automatically connect to the available network using the first network access technology when a network identifier associated with the available network is stored in a memory module coupled to the network adapter. Other embodiments may be described.

### RELATED APPLICATIONS

None.

### BACKGROUND

As wireless communication technology evolves, multiple different wireless communication technologies may coexist within a given device or platform. As different wireless communication technologies may have benefits and superior performance in a particular usage scenario, it may be advantageous to enable multiple wireless communication technologies to be used for a particular device.

Electronic devices adapted to use multiple wireless communication technologies, (which may be referred to herein as “Wireless Multicomm” hosts) may include, or may be adapted to receive, a network adapter that combines more then one wireless technology. Each wireless technology may be referred to herein as a “comm.’ Further, different wireless communication technologies may share some hardware components, e.g., radio, antenna, and/or logic on the device. Sharing hardware components may limit the usage of the device in a way that at a given time only one of the wireless communication technologies can use the hardware to transmit or receive. Other platforms may include two or more separate comms (for example, but not limited to, networks conforming to the Institute for Electronic and Electrical Engineer's (IEEE) 802.16 (WiMAX) network and networks conforming to the IEEE 802.11 (WiFi) network), that do not share any HW components, but the ability of both comms to transmit and receive simultaneously might be limited due to mutual (RF) interference.

Accordingly, systems and method to manage scanning and handover in wireless multicomm devices may find utility.

### BRIEF DESCRIPTION OF THE DRAWINGS

The detailed description is described with reference to the accompanying figures.

FIG. 1 is a schematic illustration of an architecture for a network adapter which may implement autonomous scanning and handover, according to some embodiments.

FIG. 2 is a schematic illustration of a handover environment, according to embodiments.

FIG. 3 is a schematic illustration of an electronic device which may be adapted to implement autonomous scanning and handover, according to embodiments.

FIG. 4 is a flow diagram illustrating operations in a method to implement a handover from a WiMAX access network to a WiFI access network, according to some embodiments.

### DETAILED DESCRIPTION

Described herein are exemplary methods and network nodes which provides for radio handover between heterogeneous networks, e.g., between a WiMAX access network and a WiFi access network. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

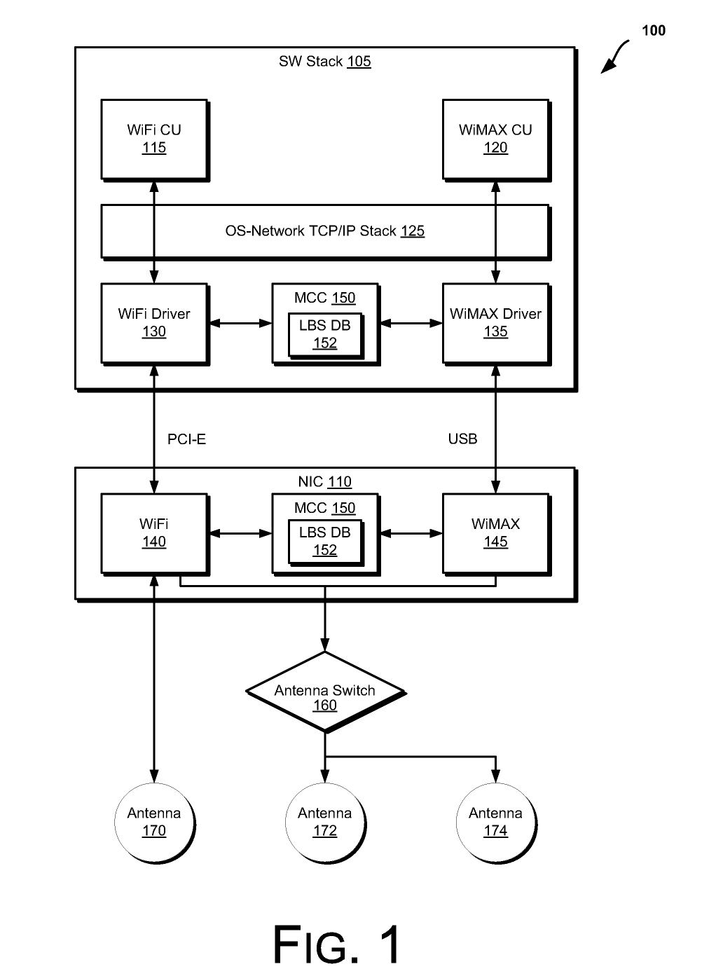

FIG. 1 is a schematic illustration of an architecture for a network adapter which may implement autonomous scanning and handover, according to some embodiments. Referring to FIG. 1, shown generally as 100, is an example of a network adapter that provides both a WiFi network access comm. 140 and a WiMAX network access comm. 145 within an integrated network interface card (NIC) 110. The WiFi comm 140 may be directly coupled to one or more antennas 170. The WiMAX comm and the WiFi comm may be coupled to an antenna switch 160, which may selectively couple the devices to one or more antennas 172, 174.

The NIC 110 may be coupled with a software stack 105 may be interfaced via a USB bus or PCI-E bus. Software stack 105 may include a WiFi connection utility application 115 in communication with WiFi driver 130 and WiMAX connection utility application 120 in communication with WiMAX driver 135 via an OS-network TCP/IP stack 125.

In some embodiments a multicomm controller (MCC) 150 is included in at lest one of the NIC 110 or the software stack 105. The MCC 150 may comprise, or be coupled to a location base service database (LBS-DB) 152. In some embodiments the LSB-DB 152 may be used to store a list of network identifiers for available networks discovered during a scanning process, as described in greater detail below. The LBS DB 152 may be implemented as computer readable memory module in, or coupled to, the MCC 150.

The multicomm entities, e.g., the WiFi network access comm 140 and the WiMAX network access comm, may be loosely or tightly coupled, with different levels of device autonomous. In some embodiments the multicomm device can be controlled using a centralized management technique in which a single connection utility (also known as Connection Manager) is aware of the multicomm device unique design. This utility is aware of the connectivity status of all comms, which may own shared resources, and it can make connectivity decisions based on that knowledge. Alternatively, the multicomm device may be controlled using a distribute management technique, in which each of the comms has its own Connection Utility (CU). All CUs may be aware of the multicomm device unique design. In this configuration, when one comm needs to gain the shared resources it might ask for the user permission to disassociate the other comm. Each CU may be aware of the connectivity status of the other comms. In some embodiments the connection utilities (CU) may not be aware of the multicomm device limitation.

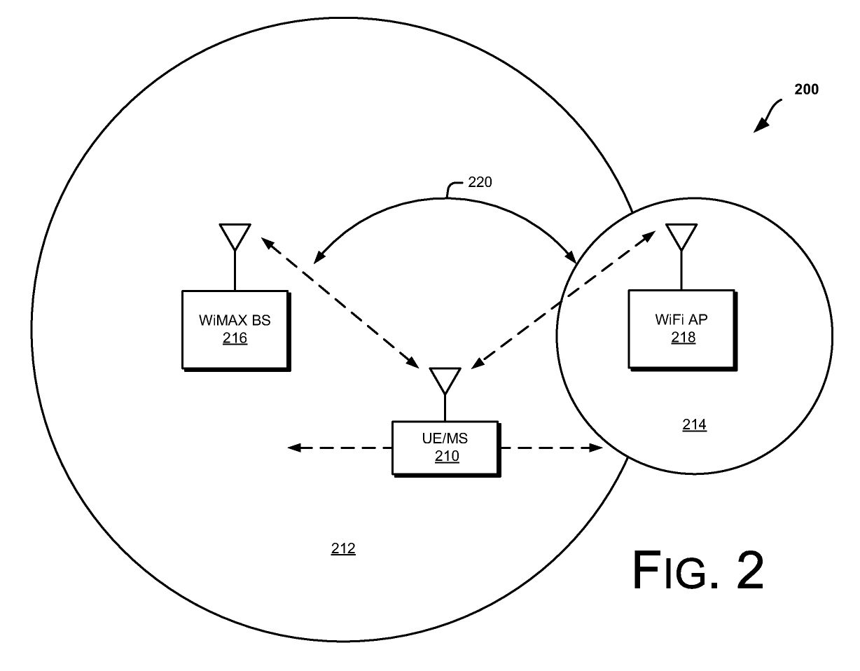

FIG. 2 is a schematic illustration of a handover environment, according to embodiments. Referring now to FIG. 2, wireless network 200 may comprise a WiMAX access network coverage area 212 disposed proximate to a WiFi access network coverage area 214. WiMAX access network coverage area 212 may be serviced by one or more WiMAX Base Station(s) (WiMAX BS) 216, and likewise WiFi access network coverage area 214 may be serviced by a WiFi access point 218, although the scope of the claimed subject matter is not limited in this respect.

In one or more embodiments, a user equipment/mobile station (UE/MS) 210 may be in a geographic position to be serviced by both a WiMAX access network coverage area 212 and WiFi access network coverage area 214. If mobile station 210 moves from WiMAX coverage area 112 to WiFi access network coverage area 214, or if mobile station 210 moves from WiFi access network coverage area 214 to WiMAX coverage area 212, a handover operation 220 may occur between the WiMAX access network to the WiFi access network, or from the WiFi access network to the WiMAX access network, respectively. In one or more embodiments, handover operation 220 may implement a handover method between WiMAX and WiFi services where the mobile station 210 may have at least one radio active at any given time.

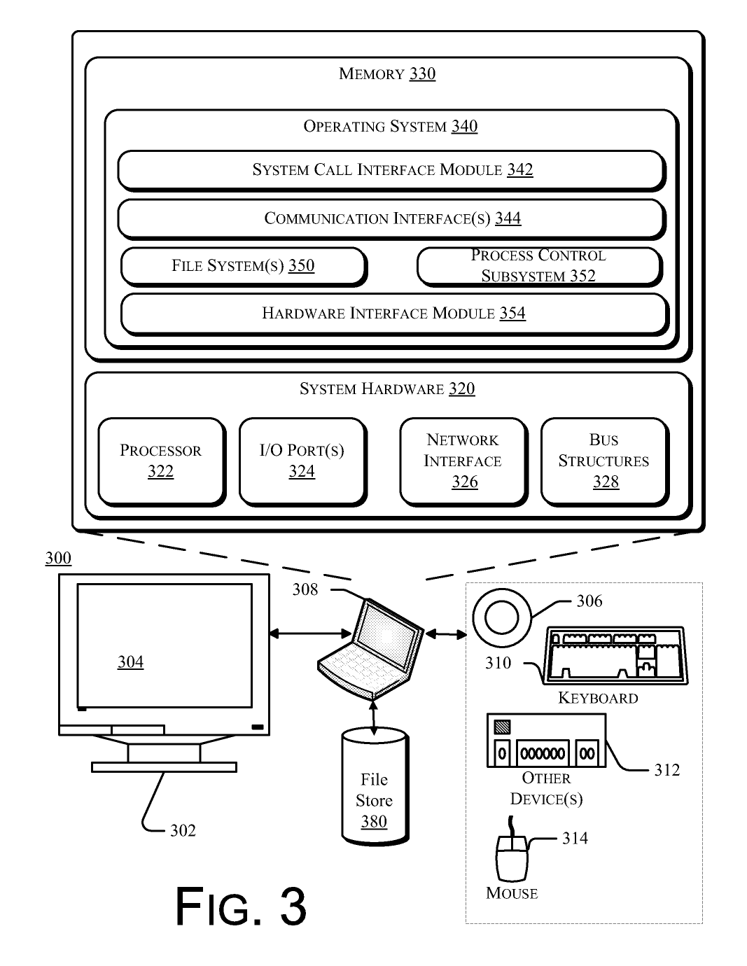

FIG. 3 is a schematic illustration of an electronic device 300 which may be include a network adapter adapted to implement autonomous scanning and handover, according to embodiments. By way of example, and not limitation, electronic device 300 may be one embodiment of the UE/MS 210 depicted in FIG. 2 and may utilize a network interface card 110 to provide access to at least one of the WiMAX network 212 or WiFi network 214 depicted in FIG. 2. In one embodiment, electronic device 300 may be implemented as a computer-based system that may be coupled to one or more networks.

Referring to FIG. 3, system 300 includes system hardware 320 and memory 330, which may be implemented as random access memory and/or read-only memory. System hardware 320 may include one or more processors 322, input/output ports 324, network interfaces 326, and bus structures 328. In one embodiment, processor 322 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

In one embodiment, network interface 326 may comprise the NIC and software stack 105 depicted in FIG. 1. Thus, the network interface 326 may provide a wired interface such as a wireless interface would be a general packet radio service (GPRS) interface, a WiMAX interface, a 3G interface, a WiFi interface, or the like. In other embodiments, the network interface may be an Ethernet interface (see, e.g., Institute of Electrical and Electronics Engineers/IEEE 802.3-2002) or a wireless interface such as an IEEE 802.11a, b, g, or n-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Bus structures 328 connect various components of system hardware 320. In one embodiment, bus structures 328 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 330 may include an operating system 340 for managing operations of electronic device 300. In one embodiment, operating system 340 includes a hardware interface module 354 that provides an interface to system hardware 320. In addition, operating system 340 may include a file system 350 that manages files used in the operation of electronic device 300 and a process control subsystem 352 that manages processes executing on electronic device 300.

Operating system 340 may include (or manage) one or more communication interfaces 344 that may operate in conjunction with system hardware 320 to transceive data packets and/or data streams from a remote source. Operating system 340 may further include a system call interface module 342 that provides an interface between the operating system 340 and one or more application modules resident in memory 330. Operating system 340 may be embodied as a UNIX operating system or any derivative thereof (e.g., Linux, Solaris, etc.) or as a Windows® brand operating system, or other operating systems.

In various embodiments, the electronic device 300 may be coupled to a computing device 308, e.g., a personal computer, a laptop computer, a personal digital assistant, a mobile telephone, an entertainment device, or another computing device. Electronic device 300 may also be coupled to one or more accompanying input/output devices including a display 302 having a screen 304, one or more speakers 306, a keyboard 310, one or more other I/O device(s) 312, and a mouse 314. The other I/O device(s) 312 may include a touch screen, a voice-activated input device, a track ball, and any other device that allows the computing device 308 to receive input from a user.

A file store 380 may be communicatively coupled to one or more of the electronic device 300 or computing device 308. File store 380 may be an internal device such as, e.g., one or more hard drives, CD-ROM drives, DVD-ROM drives, or other types of storage devices. File store 380 may also be external to computer 308 such as, e.g., one or more external hard drives, network attached storage, or a separate storage network.

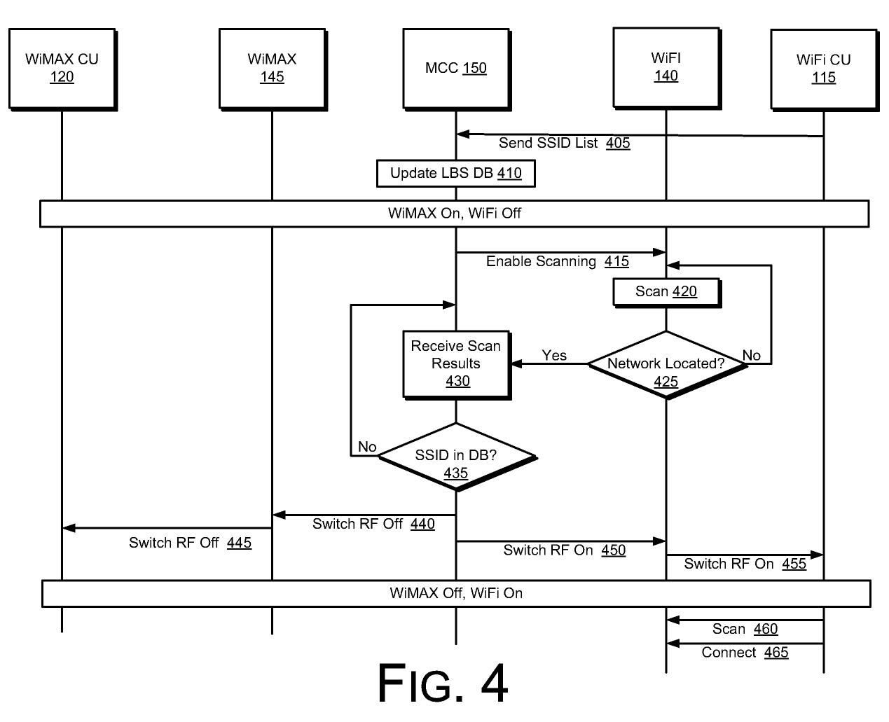

In some embodiments a network adapter such as the adapter depicted in FIG. 1 may be used to implement autonomous scanning and handover between different network access technologies in an electronic device, such as the electronic device depicted in FIG. 3. FIG. 4 is a flow diagram illustrating operations in a method to implement a handover from a WiMAX access network to a WiFI access network, according to some embodiments. FIG. 4 depicts the interaction between the WiMAX connection utility 120, the WiMAX module 145, the multicomm controller 150, the WiFI module 140 and the WiFi connection utility 115. In the embodiment depicted in FIG. 4 it is presumed that the NIC 110 begins with a connection to the WiMAX access network 212.

At operation 405 the WiFi connection utility 115 (or another userspace application) sends a list of network identifiers to which the device may connect to the muilticomm controller 150. By way of example, the WiFi connection utility 115 may maintain a list of service set identifiers (SSIDs) associated with one or more wireless networks that have an autoconnect profile registered with the WiFi connection utility. One skilled in the art will recognize that alternate network identifiers may be used. At operation 410 the multicomm controller 150 updates the location base service database 152 with the network identifiers provided by the WiFi connection utility 115.

At operation 415 the multicomm controller 150 passes an enable scanning message to the WiFi module 140. At operation 420 the WiFi module initiates a scanning procedure to scan for available WiFi networks. In some embodiments the scanning operation may be performed only when the WiMAX radio is on and the WiFi radio is off. In alternate embodiments the scanning procedure may be implemented without regard to the state of the radio.

At operation 425 the WiFi module 140 determines whether any networks were located in the scanning operation implemented at operation 420. If, at operation 425, no networks were located then control passes back to operation 420 and the scan is continued. In some embodiments the scan may be triggered periodically, as a function of a time parameter. By contrast, if at operation 425 the WiFi module 140 locates one or more new networks during the scan operation implemented at operation 420, then the network identifiers associated with the located networks are forwarded to the multicomm controller 150.

At operation 430 the multicomm controller 150 receives the scan results from the WiFi module 140. At operation 435 the multicomm controller 150 determines whether the network identifier(s) received with the scan results are in the location base service database 152. By way of example, the multicomm controller 150 may compare the received network identifier(s) with those stored in the list of identifiers in the location base service database 152. If, at operation 435 the received identifier(s) are not in the location base service database 152, then control passes back to operation 430 and the multicomm controller 150 waits to receive scan results from another scan.

By contrast, if at operation 435 the network identifier is in the location base service database 152 then control passes to operation 440 and the multicomm controller 150 instructs the WiMAX module 145 to switch off the RF transceiver for the WiMAX module. The WiMAX module 145 may pass this instruction to the WiMAX connection utility 120 (operation 445). Further, at operation 450 the multicomm controller 150 instructs the WiFi module 140 to switch on the RF transceiver for the WiFi module. The WiFi module 140 may pass this instruction to the WiFi connection utility 115 (operation 455).

At operation 460 the WiFi connection utility 115 transmits a scan message to the WiFi module 140, and at operation 465 the WiFi connection utility 115 transmits a connect massage to the WiFi module 140, whereupon the WiFi module 140 establishes a connection with the WiFi network 214. Thus, the operations of FIG. 4 enable a UE/MS 210 to autonomously switch from a WiMAX access network to a WiFi access network.

While particular terminology is used herein to describe various components and methods, one skilled in the art will recognize that such terminology is intended to be descriptive and not limiting. By way of example, the phrase “wireless device” is intended to refer to any type of device which can transmit or receive data on the network. It will be understood that these phrases are intended to apply to multiple different wireless networking standards and to networking standards and configurations not yet described or implemented.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method, comprising:
maintaining, in a nontransitory computer readable storage medium, a list of one or more network identifiers for an IEEE 802.11 (WiFi) network access technology;
locating an available network utilizing the IEEE 802.11 (WiFi) network access technology;
determining whether an identifier associated with the available network is stored in the nontransitory computer readable storage medium; and
in response to a determination that an identifier associated with the available network is stored in the nontransitory computer readable storage medium:
disabling a network connection with an IEEE 802.16 (WiMAX) network access technology; and
connecting to the available network.

2. The method of claim 1, wherein maintaining, in a nontransitory computer readable storage medium, a list of one or more network identifiers for an IEEE 802.11 (WiFi) network access technology comprises maintaining a list of service set identifiers (SSIDs) for one or more WiFi networks.

3. The method of claim 1, wherein locating an available network utilizing the an IEEE 802.11 (WiFi) network access technology comprises implementing a scanning operation in which a network access device scans for one or more available networks.

4. The method of claim 1, wherein determining whether an identifier associated with the available network is stored in the nontransitory computer readable storage medium comprises comparing the identifier associated with the available network with the list of identifiers in the nontransitory computer readable storage medium.

5. The method of claim 1, further comprising:
disabling the transmitter for the IEEE 802.16 (WiMAX) network.

6. A network adapter, comprising:
an IEEE 802.11 (WiFi) network access technology and an IEEE 802.16 (WiMAX) network access technology; and
a controller comprising logic to:
locate an available network which utilizes the IEEE 802.11 (WiFi) network access technology; and
automatically connect to the available network using the IEEE 802.11 (WiFi) network access technology when a network identifier associated with the available network is stored in a memory module coupled to the network adapter.

7. The network adapter of claim 6, further comprising:
at least one antenna; and
an antenna switch to couple the network adapter to the at least one antenna.

8. The network adapter of claim 7, further comprising a software stack which executes on a processor communicatively coupled to the network adapter, wherein the software stack comprises:
a WiFi connection utility coupled to the network adapter via a WiFi driver; and
a WiMAX connection utility coupled to the network adapter via a WiMAX driver.

9. The network adapter of claim 6, wherein the memory module is embedded in the controller.

10. The network adapter of claim 7, wherein the controller maintains, in the memory module, a list of one or more network identifiers for the IEEE 802.11 (WiFi) network access technology.

11. The network adapter of claim 10, further comprising:
a WiFi comm to establish a connection with a WiFi network; and
a WiMAX comm to establish a connection with a WiMAX network.

12. The network adapter of claim 13, wherein the WiFi module initiates a scanning operation in which a network access device scans for one or more available networks.

13. The network adapter of claim 7, further comprising logic to disable the transmitter for the second network access technology.

14. An electronic device, comprising:
at least one processor; and
a network adapter to couple the electronic device to one or more networks, the network adapter comprising:
a first network access technology and a second network access technology; and
a controller comprising logic to:
locate an available network which utilizes the IEEE 802.11 (WiFi) network access technology; and
automatically connect to the available network using the IEEE 802.11 (WiFi) network access technology when a network identifier associated with the available network is stored in a memory module coupled to the network adapter.

15. The electronic device of claim 14, further comprising:
at least one antenna; and
an antenna switch to couple the network adapter to the at least one antenna.

16. The electronic device of claim 14, further comprising a software stack which executes on a processor communicatively coupled to the network adapter, wherein the software stack comprises:
a WiFi connection utility coupled to the network adapter via a WiFi driver; and
a WiMAX connection utility coupled to the network adapter via a WiMAX driver.

17. The electronic device of claim 14, wherein the controller maintains, in the memory module, a list of one or more network identifiers for a first network access technology.

18. A network adapter, comprising:
an IEEE 802.11 (WiFi) network access technology and an IEEE 802.16 (WiMAX) network access technology;
a memory module to store a list of IEEE 802.11 WiFi networks and connection information associated with the networks; and
a controller comprising logic to:
locate an available network which utilizes the IEEE 802.11 (WiFi) network access technology; and
autonomously connect to the available network using the IEEE 802.11 (WiFi) network access technology when a network identifier associated with the available network is stored in a memory module coupled to the network adapter.

19. The network adapter of claim 18, wherein the WiFi module initiates a scanning operation in which a network access device scans for one or more available networks.

20. The network adapter of claim 18, further comprising logic to disable the transmitter for the IEEE 802.16 (WiMAX) network access technology.
